(19) United States
(12) Patent Application Publication
(10) Pub. No.: US 2016/0062423 A1
(43) Pub. Date: Mar. 3, 2016

(54) METHOD FOR MANAGING HEAT GENERATION IN ELECTRONIC DEVICE AND ELECTRONIC DEVICE THEREFOR

(71) Applicant: Samsung Electronics Co., Ltd., Suwon-si (KR)

(72) Inventors: Byung-Wook KIM, Suwon-si (KR); Ju-Beam LEE, Yongin-si (KR); Seung-Ho KANG, Suwon-si (KR); Moo-Young KIM, Seoul (KR)

(21) Appl. No.: 14/843,587

(22) Filed: Sep. 2, 2015

(30) Foreign Application Priority Data
Sep. 2, 2014 (KR) 10-2014-0116282

(51) Int. Cl. G06F 1/20; G06F 1/32

(52) U.S. Cl. CPC G06F 1/206; G06F 1/3206; G06F 1/3234

(57) ABSTRACT

Provided is a method for managing heat generation in an electronic device. The method includes determining a state of the electronic device, applying a performance level for at least one element associated with heat generation, corresponding to the state, monitoring state information of the electronic device, and adjusting the performance level for the at least one element according to the state information. Various embodiments are also possible.

### RELATED APPLICATION(S)

This application claims the benefit under 35 U.S.C. §119(a) of a Korean patent application filed in the Korean Intellectual Property Office on Sep. 2, 2014 and assigned Serial No. 10-2014-0116282, the entire disclosure of which is incorporated herein by reference.

### TECHNICAL FIELD

The present disclosure relates to a method for managing heat generation in an electronic device and the electronic device therefor.

### BACKGROUND

Electronic devices such as a smartphone, a Personal Computer (PC), a tablet PC, and so forth provide various useful functions to users through various applications. In the electronic devices, the integration of parts has been increased to support various functions while maintaining slimness for user convenience.

The increase in the integration may degrade performance and damage the parts due to heat generation as the temperature of the electronic device increases because of reduction of a space for heat generation.

In a way to solve the heat generation problem of an electronic device, the electronic device may switch to a power saving mode through a power saving menu not to perform an operation causing power consumption, thus reducing the temperature. However, the power saving mode collectively limits every operation executed in the electronic device, such that although the remaining battery capacity is enough for execution of a user-desired application, normal application execution may not be possible.

As a result, if maximum performance needs to be maintained for a currently executing application in the electronic device, the heat generation problem may not be solved. Moreover, if an external accessory is mounted on the electronic device, the heat generation problem may occur due to characteristics of the external accessory.

The above information is presented as background information only to assist with an understanding of the present disclosure. No determination has been made, and no assertion is made, as to whether any of the above might be applicable as prior art with regard to the present disclosure.

### BRIEF SUMMARY

An aspect of the present disclosure is to address at least the above-mentioned problems and/or disadvantages and to provide at least the advantages described below. Accordingly, an aspect of the present disclosure is to provide an apparatus and method for efficiently managing heat generation in a state where performance is optimized according to a type of an external accessory if the external accessory is mounted on an electronic device.

Another aspect of the present disclosure is to provide an apparatus and method for efficiently managing heat generation while maintaining optimal performance for a currently executing application.

In accordance with an aspect of the present disclosure, there is provided a method for managing heat generation in an electronic device, the method including determining a state of the electronic device, applying a performance level for at least one element associated with heat generation, corresponding to the state, monitoring state information of the electronic device, and adjusting the performance level for the at least one element according to the state information.

In accordance with another aspect of the present disclosure, there is provided an electronic device for managing heat generation, the electronic device including a monitoring unit configured to monitor state information of the electronic device and a controller configured to determine a state the electronic device, to apply a performance level for at least one element associated with heat generation, corresponding to the state, and to adjust the performance level for the at least one element according to the state information.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF SEVERAL VIEWS OF THE DRAWINGS

The above and other aspects, features and advantages of certain exemplary embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of a program module according to various embodiments of the present disclosure;

FIG. 3A and FIG. 3B are exterior perspective views illustrating states where a cover is coupled to an electronic device according to various embodiments of the present disclosure;

FIG. 4A schematically illustrates a cover of an electronic device according to various embodiments of the present disclosure;

FIG. 4B schematically illustrates a rear surface of a cover of an electronic device according to various embodiments of the present disclosure;

FIG. 5 schematically illustrates a cover of an electronic device according to various embodiments of the present disclosure;

FIG. 6 is a block diagram of an electronic device for managing heat generation according to various embodiments of the present disclosure;

FIG. 7 illustrates a performance level table according to various embodiments of the present disclosure;

FIG. 8 is a flowchart illustrating an operation for adjusting a performance level based on an accessory type according to various embodiments of the present disclosure;

FIG. 9 illustrates performance level adjustment for each configuration element based on a temperature variation according to various embodiments of the present disclosure;

FIG. 10A and FIG. 10B illustrate performance level adjustments according to various embodiments of the present disclosure;

FIG. 11 is a flowchart illustrating an operation for adjusting a performance level based on an application according to another embodiment of the present disclosure;

FIG. 12 illustrates a process of updating a performance level table based on execution of an application according to various embodiments of the present disclosure;

FIG. 13 illustrates a process of adjusting a performance level based on a type of an application according to various embodiments of the present disclosure; and

FIG. 14 is a block diagram of an electronic device according to various embodiments of the present disclosure.

Throughout the drawings, like reference numerals will be understood to refer to like parts, components, and structures.

### DETAILED DESCRIPTION

Hereinafter, various embodiments of the present disclosure will be disclosed with reference to the accompanying drawings. However, the description is not intended to limit the present disclosure to particular embodiments, and it should be construed as including various modifications, equivalents, and/or alternatives according to the embodiments of the present disclosure. In regard to the description of the drawings, like reference numerals refer to like elements.

In the present disclosure, an expression such as “having,” “may have,” “comprising,” or “may comprise” indicates existence of a corresponding characteristic (such as an element such as a numerical value, function, operation, or component) and does not exclude existence of additional characteristic.

In the present disclosure, an expression such as “A or B,” “at least one of A or/and B,” or “one or more of A or/and B” may include all possible combinations of together listed items. For example, “A or B,” “at least one of A and B,” or “one or more of A or B” may indicate the entire of (1) including at least one A, (2) including at least one B, or (3) including both at least one A and at least one B.

Expressions such as “first,” “second,” “primarily,” or “secondary,” used in various exemplary embodiments may represent various elements regardless of order and/or importance and do not limit corresponding elements. The expressions may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that an element (such as a first element) is “operatively or communicatively coupled” to or “connected” to another element (such as a second element), the element can be directly connected to the other element or can be connected to the other element through a third element. However, when it is described that an element (such as a first element) is “directly connected” or “directly coupled” to another element (such as a second element), it means that there is no intermediate element (such as a third element) between the element and the other element.

An expression “configured to (or set)” used in the present disclosure may be replaced with, for example, “suitable for,” “having the capacity to,” “designed to,” “adapted to,” “made to,” or “capable of” according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a generic-purpose processor (such as a CPU or an application processor) that can perform a corresponding operation by executing at least one software program stored at an exclusive processor (such as an embedded processor) for performing a corresponding operation or at a memory device.

Terms defined in the present disclosure are used for only describing a specific exemplary embodiment and may not have an intention to limit the scope of other exemplary embodiments. When using in a description of the present disclosure and the appended claims, a singular form may include a plurality of forms unless it is explicitly differently represented. Entire terms including a technical term and a scientific term used here may have the same meaning as a meaning that may be generally understood by a person of common skill in the art. It may be analyzed that generally using terms defined in a dictionary have the same meaning as or a meaning similar to that of a context of related technology and are not analyzed as an ideal or excessively formal meaning unless explicitly defined. In some case, terms defined in the present disclosure cannot be analyzed to exclude the present exemplary embodiments.

An electronic device according to various embodiments of the present disclosure may include, for example, at least one of a smart phone, a tablet Personal Computer (PC), a mobile phone, a video phone, an electronic (e-)book reader, a desktop PC, a laptop PC, a netbook computer, a workstation, a server, a Personal Digital Assistant (PDA), a Portable Multimedia Player (PMP), an MP3 player, mobile medical equipment, a camera, a wearable device (e.g., smart glasses, a Head-Mounted Device (HMD)), an electronic cloth, an electronic bracelet, an electronic necklace, an electronic accessory, an electronic tattoo, a smart mirror, and a smart watch.

In some embodiments, the electronic device may be a smart home appliance. The smart home appliance may include, for example, a Television (TV), a Digital Video Disk (DVD) player, audio equipment, a refrigerator, an air conditioner, a vacuum cleaner, an oven, a microwave oven, a laundry machine, an air cleaner, a set-top box, a home automation control panel, a security control panel, a TV box (e.g., HomeSync™ of Samsung, TV™ of Apple, or TV™ of Google), a game console (e.g., Xbox™ or PlayStation™), an electronic dictionary, an electronic key, a camcorder, and an electronic frame.

In another embodiment, the electronic device may include at least one of various medical equipment (e.g., various portable medical measurement devices such as a blood sugar measurement device, a heartbeat measurement device, a blood pressure measurement device, or a body temperature measurement device), Magnetic Resonance Angiography (MRA), Magnetic Resonance Imaging (MRI), Computed Tomography (CT), an imaging device, or an ultrasonic device), a navigation system, a Global Positioning System (GPS) receiver, an Event Data Recorder (EDR), a Flight Data Recorder (FDR), a vehicle infotainment device, electronic equipment for ships (e.g., navigation system and gyro compass for ships), avionics, a security device, a vehicle head unit, an industrial or home robot, an Automatic Teller's Machine (ATM), a Point of Sales (PoS) of stores, and the Internet of things (e.g., electric bulbs, various sensors, electricity or gas metering devices, spring cooler devices, fire alarm systems, thermostats, streetlights, toasters, exercise machines, warm water tanks, heating systems, boiling systems, and so forth).

According to some embodiments, the electronic device may include a part of a furniture or building/structure, an electronic board, an electronic signature receiving device, a projector, and various measuring instruments (e.g., a water, electricity, gas, or electric wave measuring device). The electronic device according to various embodiments of the present disclosure may be one of the above-listed devices or a combination thereof. The electronic device according to some embodiment of the present disclosure may be a flexible electronic device. The electronic device according to an embodiment of the present disclosure is not limited to the above-listed devices and may also include various electronic devices according to technology development.

Hereinafter, the electronic device according to various embodiments will be described with reference to the accompanying drawings. The term “user” used in the various embodiments may indicate a person who uses the electronic device or a device (e.g., an artificial intelligence electronic device) which uses the electronic device.

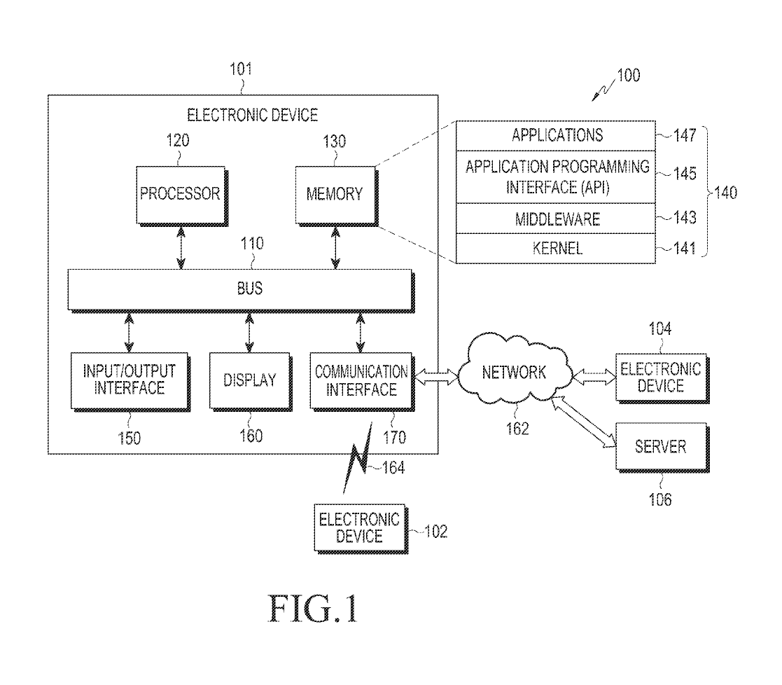

Referring to FIG. 1, an electronic device 101 in a network environment according to various embodiments of the present disclosure will be described. The electronic device 101 may include a bus 110, a processor 120, a memory 130, an input/output interface 150, a display 160, and a communication interface 170. In some embodiments, at least one of the foregoing elements may be omitted from the electronic device 101 or other elements may be further included in the electronic device 101.

The bus 110 is a circuit for connecting the foregoing elements 110 through 170 with each other and delivering communication (e.g., a control message and/or data) between the elements 110 through 170.

The processor 120 may include one or more of a Central Processing Unit (CPU), an Application Processor (AP), and a Communication Processor (CP). The processor 120 may perform operations or data processing for control and/or communication of at least one other elements of the electronic device 101.

The processor 120 may be referred to as a controller or may include the controller as a part thereof

The processor 120 according to various embodiments of the present disclosure determines a type of an external accessory coupled to or contacting the electronic device 101, applies a performance level to each of at least one element associated with heat generation, corresponds to the type of the external accessory, monitors a temperature of heat generated by the at least one element, and adjusts a performance level for the at least one element according to a temperature variation.

The memory 130 may include a volatile and/or non-volatile memory. The memory 130 may store a command or data associated with at least one other components of the electronic device 101. According to an embodiment, the memory 130 may store software and/or program 140. The program 140 may include, for example, a kernel 141, a middleware 143, an Application Programming Interface (API) 145 and/or an application program (or application) 147.

At least a part of the kernel 141, the middleware 143, and the API 145 may be referred to as an Operating System (OS).

The kernel 141 controls or manages system resources (e.g., the bus 110, the processor 120, and the memory 130) used to execute an operation or a function implemented in the other programming modules, for example, the middleware 132, the API 145, and the application program 147. The kernel 141 provides an interface through which the middleware 143, the API 145, or the application 147 accesses a separate component of the electronic device 101 to control system resources.

The middleware 143 performs a relay operation such that the API 145 or the application program 147 exchanges data in communication with the kernel 141. The middleware 143 performs control (e.g., load balancing) for task requests received from the application program 147, by using a method of assigning a priority for using a system resource (e.g., the bus 110, the processor 120, or the memory 130) of the electronic device 101 to, for example, at least one of the application program 147.

The API 145 is an interface through which the application 147 controls a function provided by the kernel 141 or the middleware 143, and may include at least one interface or function (e.g., a command) for, for example, file control, window control, image processing or character control.

The input/output interface 150 may serve as an interface for delivering a command or data input from a user or another external device to other element (s) 110 through 140, 160, and 170 of the electronic device 101. The input/output device 150 may also output a command or data received from other element(s) 110 through 140, 160, and 170 of the electronic device 101 to the user or another external device.

The display 160 may include a Liquid Crystal Display (LCD), a Light Emitting Diode (LED) display, an Organic Light Emitting Diode (OLED) display, a Micro-Electro-Mechanical System (MEMS) display, or an electronic paper display. The display 160 may display, for example, various contents (e.g., texts, images, video, icons, or symbols) to the user. The display 160 may include a touch screen, and may receive touch, gesture, proximity or hovering inputs by using electronic pens or user's body parts.

The communication interface 170 may set communication between the electronic device 101 and an external device (e.g., a first external electronic device 102, a second external electronic device 104, or a server 106). For example, the communication interface 170 may be connected to a network 162 over wireless or wired communication to communicate with the external device (e.g., the second external electronic device 104 or the server 106).

The wireless communication may use, as a cellular communication protocol, at least one of Long Term Evolution (LTE), LTE-Advanced (LTE-A), Code Division Multiple Access (CDMA), Wideband Code Division Multiple Access (WCDMA), Universal Mobile Telecommunication System (UMTS), Wireless Broadband (WiBro), and Global System for Mobile Communications (GSM). The wired communication may include at least one of a Universal Serial Bus (USB), a High Definition Multimedia Interface (HDMI), Recommended Standard 232 (RS-232), and a Plain Old Telephone Service (POTS). The network 162 may include a telecommunications network, for example, at least one of a computer network (e.g., a Local Area Network (LAN) or a Wide Area Network (WAN)), the Internet, and a telephone network.

Each of the first external electronic device 102 and the second external electronic device 104 may be the same type as or a different type than that of the electronic device 101. According to an embodiment of the present disclosure, the server 106 may include a group of one or more servers.

According to various embodiments, all or some of operations performed in the electronic device 101 may be performed in another electronic device or a plurality of electronic devices (e.g., the electronic devices 102 and 104 or the server 106). According to an embodiment of the present disclosure, when the electronic device 101 has to perform a function or a service automatically or at the request, the electronic device 101 may request another device (e.g., the electronic devices 102 and 104 or the server 106) to perform at least some functions associated with the function or the service instead of or in addition to executing the function or the service. The another electronic device (e.g., the electronic devices 102 and 104 or the server 106) may perform the requested function or an additional function and delivers the result to the electronic device 101. The electronic device 101 provides the received result or provides the requested function or service by processing the received result. To this end, for example, cloud computing, distributed computing, or client-server computing may be used.

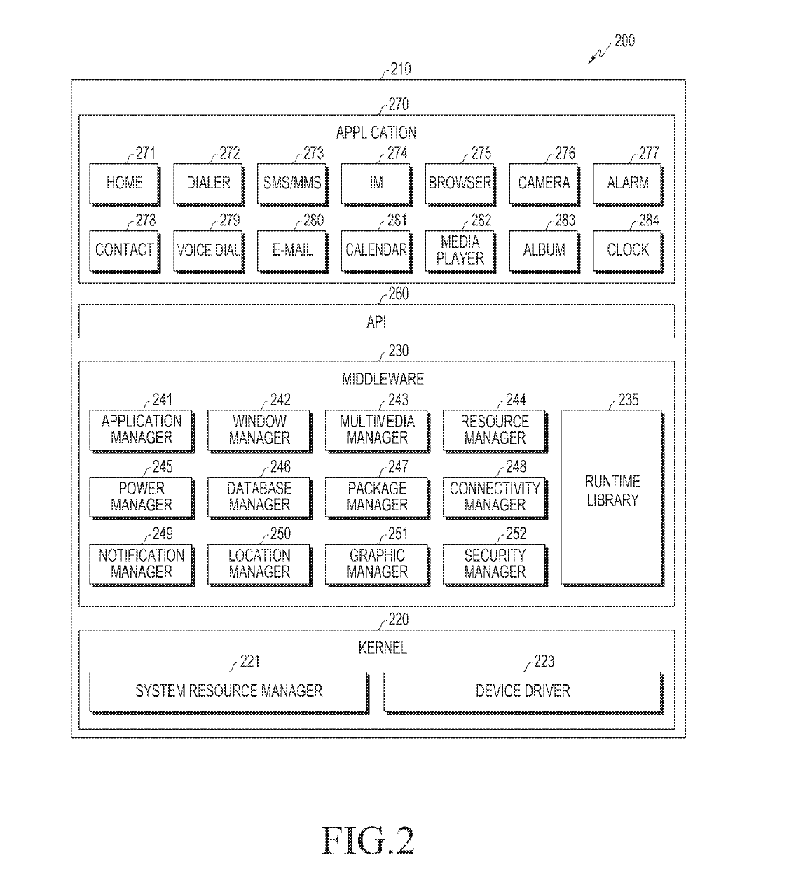

FIG. 2 is a block diagram 200 illustrating a programming module 210 according to various embodiments of the present disclosure. According to an embodiment, the programming module 210 (e.g., the program 140) may include an Operation System (OS) for controlling resources associated with an electronic device (e.g., the electronic device 101) and/or various applications executed on the OS. The OS may include Android, iOS, Windows, Symbian, Tizen, or Bada.

The programming module 210 may include a kernel 220, a middleware 230, an application programming interface (API) 260, and/or an application 270. At least a part of the programming module 210 may be preloaded on an electronic device or may be downloaded from a server (e.g., the server 106).

The kernel 220 (e.g., the kernel 141 of FIG. 1) may include a system resource manager 221 and a device driver 223. The system resource manager 221 may perform control, allocation, or retrieval of system resources. According to an embodiment, the system resource manager 221 may include a process management unit, a memory management unit, or a file system. The device driver 223 may include, for example, a display driver, a camera driver, a Bluetooth driver, a shared memory driver, a USB driver, a keypad driver, a WiFi driver, an audio driver, or an Inter-Process Communication (IPC) driver.

The middleware 230 may include functions that the application 270 commonly requires or provide various functions to the application 270 through the API 260 to allow the application 270 to efficiently use a limited system resource in an electronic device (e.g., the electronic device 101 of FIG. 1). According to an embodiment, the middleware 230 (e.g., the middleware 143) may include at least one of a runtime library 235, an application manager 241, a window manager 242, a multimedia manager 243, a resource manager 244, a power manager 245, a database manager 246, a package manager 247, a connectivity manager 248, a notification manager 249, a location manager 250, a graphic manager 251, and a security manager 252.

The runtime library 235 may include a library module that a compiler uses to add a new function through a programming language while the application 270 is executed. The runtime library 235 performs functions relating to an input/output, memory management, or calculation operation.

The application manager 241 manages a life cycle of at least one application of the application 270. The window manager 242 manages a GUI resource using a screen (e.g., the input/output interface 150, or the display 160 of FIG. 1). The multimedia manager 243 recognizes a format necessary for playing various media files and performs encoding or decoding on a media file by using a codec appropriate for a corresponding format. The resource manager 244 manages a resource such as source code, memory, or storage space of at least one application of the application 270.

The power manager 245 manages a battery or power in operation with a basic input/output system (BIOS) and provides power information necessary for an operation of the electronic device. The database manager 246 performs a management operation to generate, search or change a database used for at least one application among the applications 270. The package manager 247 manages the installation or update of an application distributed in a package file format.

The connectivity manager 248 manages a wireless connection such as a WiFi or Bluetooth connection. The notification manager 249 displays or notifies events such as arrival messages, appointments, and proximity alerts in a manner that is not disruptive to a user. The location manager 250 manages location information of an electronic device. The graphic manager 251 manages a graphic effect to be provided to a user or a user interface relating thereto. The security manager 252 provides a general security function necessary for system security or user authentication. According to an embodiment of the present disclosure, when an electronic device (e.g., the electronic device 101 of FIG. 1) has a call function, the middleware 230 may further include a telephony manager for managing a voice or video call function of the electronic device.

The middleware 230 may include a middleware module forming a combination of various functions of the above-mentioned internal elements. The middleware 230 may provide modules specified according to types of OS so as to provide distinctive functions. Additionally, the middleware 230 may delete some of existing elements or add new elements dynamically.

The API 260 (e.g., the API 145) may be provided as a set of API programming functions with a different configuration according to the OS. In the case of Android or iOS, for example, one API set may be provided by each platform, and in the case of Tizen, two or more API sets may be provided.

The application 270 (e.g., the application program 147) may include one or more applications capable of providing a function, for example, a home application 271, a dialer application 272, a Short Messaging Service/Multimedia Messaging Service (SMS/MMS) application 373, an Instant Message (IM) application 274, a browser application 275, a camera application 276, an alarm application 277, a contact application 278, a voice dial application 279, an e-mail application 280, a calendar application 281, a media player application 282, an album application 283, a clock application 284, a health care application (e.g., an application for measuring an exercise amount or a blood sugar), or an environment information providing application (e.g., an application for providing air pressure, humidity, or temperature information).

According to an embodiment of the present disclosure, the application 270 may include an application (hereinafter, an “information exchange application” for convenience) supporting information exchange between the electronic device (e.g., the electronic device 101) and an external electronic device (e.g., the electronic device 102 or 104). The information exchange application may include, for example, a notification relay application for transferring specific information to the external electronic device or a device management application for managing the external electronic device.

For example, the notification relay application may include a function for transferring notification information generated in another application (e.g., an SMS/MMS application, an e-mail application, a health care application, or an environment information application) of the electronic device to an external electronic device (e.g., the electronic device 102 or 104). The notification relay application may receive notification information from an external electronic device to provide the same to a user. The device management application may manage (e.g., install, delete, or update) at least one function (e.g., turn on/turn off of an external electronic device itself (or a part thereof) or control of brightness (or resolution) of a display, a service provided by an application operating in an external electronic device or provided by the external electronic device (e.g., a call service or a message service).

According to an embodiment, the application 270 may include an application (e.g., a health care application) designated according to an attribute (e.g., a type of an electronic device being a mobile medical device as an attribute of the electronic device) of the external electronic device (e.g., the electronic device 102 or 104). According to an embodiment, the application 270 may include an application received from the external electronic device (e.g., the server 106 or the electronic device 102 or 104). According to an embodiment, the application 270 may include a preloaded application or a third party application that may be downloaded from the server. Names of elements of the programming module 210 according to the illustrated embodiment may vary depending on a type of an OS.

According to various embodiments, at least a part of the programming module 210 may be implemented by software, firmware, hardware, or a combination of at least two of them. The at least a part of the programming module 210 may be implemented (e.g., executed) by a processor (e.g., the AP 210). The at least a part of the programming module 210 may include a module, a program, a routine, sets or instructions, or a process for performing one or more functions.

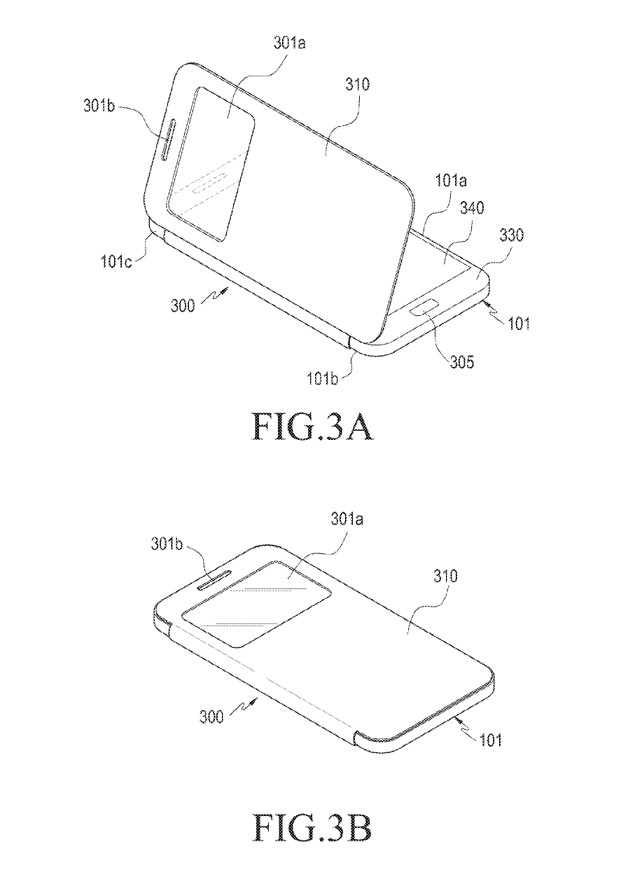

FIG. 3A and FIG. 3B are exterior perspective views illustrating states where a cover is coupled to an electronic device according to various embodiments of the present disclosure.

Referring to FIG. 3A and FIG. 3B, the electronic device 101 (of FIG. 1) according to various embodiments of the present disclosure may be coupled to or include a cover 300. The cover 300 may also be attached onto the electronic device 101. On a front surface 101a of the electronic device 101, a display device for displaying various multiple functions may include, for example, a touch screen 340. The cover 300 may be formed to cover at least a portion of the front surface 101a of the electronic device 101. A bezel 330 may also be formed on the front surface 101a of the electronic device 101 to enclose at least a portion of the touch screen 340. A home button 305, a speaker (not shown), a camera (not shown), a sensor (not shown), and the like may be formed in the bezel 330. A battery (not shown) may be formed on a rear surface 101b of the electronic device 101 to supply power to the electronic device 101.

A front cover portion 310 of the cover 300 is open or closed by flipping. When the front cover portion 310 of the cover 300 is open, the touch screen 340 of the electronic device 101 is entirely exposed as illustrated in FIG. 3A. On the other hand, when the front cover portion 310 of the cover 300 is closed, at least a portion of the touch screen 340 of the electronic device 101 is covered by the front cover portion 310 as illustrated in FIG. 3B. Referring to FIG. 3B, when the front cover portion 310 of the cover 300 is closed, a partial region of the touch screen 340 is exposed through a window region 301a of the front cover portion 310. Thus, other region of the touch screen 340 may not be exposed.

When the front cover portion 310 of the cover 300 is closed, a part (e.g., a speaker, not shown) formed on the bezel 330 of the electronic device 101 may be exposed through an opening 301b formed in the front cover portion 310. Although one opening 301b is shown in FIG. 3B, a plurality of openings may be formed in the front cover portion 310, such that a plurality of parts (e.g., a speaker, not shown, a camera, not shown, and so forth) formed on the bezel 330 of the electronic device 101 may be exposed when the front cover portion 310 is closed. Characteristics of the cover 300 are not necessarily limited to the aforementioned structure, and the cover 300 may have various forms. For example, the front cover portion 310 of the cover 300 may be formed of a transparent or semi-transparent material and the window region 301a may have the same size as the touch screen 340.

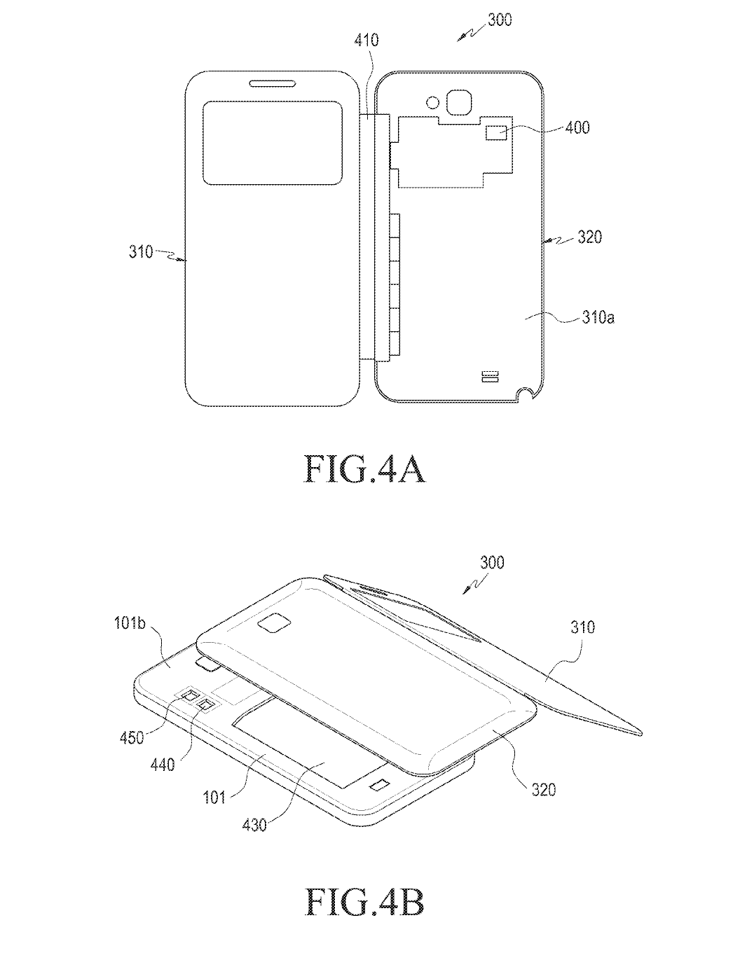

FIG. 4A schematically illustrates a cover of an electronic device according to various embodiments of the present disclosure, and FIG. 4B schematically illustrates a rear surface of a cover of an electronic device according to various embodiments of the present disclosure.

Referring to FIGS. 4A and 4B, a rear cover portion 320 may be provided on the rear surface 101b (of FIGS. 3A and 3B) of the electronic device 101 according to various embodiments of the present disclosure. On an inner surface 310a of the rear cover portion 320, a connector portion 400 capable of being electrically connected to the electronic device 101 may be further provided. The rear cover portion 320 may be coupled to the rear surface 101b of the electronic device 101, while covering a battery 430 inserted into the electronic device 101. The rear cover portion 320 may substitute for a battery cover (not shown) of the electronic device 101. The front cover portion 310 may be connected to a side surface of the rear cover portion 320. A connecting portion 410 may be formed between the rear cover portion 320 and the front cover portion 310. In this case, a side surface of the connecting portion 410 is connected to a side surface of the rear cover portion 320, and the other side surface of the connecting portion 410 is connected to a side surface of the front cover portion 310. The rear cover portion 320 and the front cover portion 310 may be bent with respect to the connecting portion 410.

When the rear cover portion 320 is coupled to the rear surface 101b of the electronic device 101, while covering the battery 430, the connecting portion 410 is electrically connected to a connection terminal formed on the rear surface 101b of the electronic device 101, thus providing cover type information. According to an embodiment, the cover type information may include identification information of the rear cover portion 320, for example, an Identifier (ID), and the identification information may have a form of a serial code. In this case, the electronic device 101 may identify a type of the cover 300 based on the identification information by referring to a table that is stored therein in advance with respect to cover-type-specific detail information. Thus, the electronic device 101 may determine information about whether the cover 300 is an original product, the performance of heat generation prevention, a cover thickness, and so forth. According to another embodiment, the cover type information may include information about the performance of heat generation prevention and the cover thickness of the rear cover portion 320.

Based on the cover type information, the electronic device 101 adjusts an operating frequency for, for example, a Central Processing Unit (CPU) by using a clock adjusting method, thus adjusting heat generation. For example, if a current cover has a first thickness larger than that of a previous cover, a temperature of the rear surface 101b of the electronic device 101 may be lowered by the current cover having the first thickness, thus increasing CPU performance by increasing the operating frequency for the CPU. On the other hand, if the current cover has a second thickness smaller than that of the previous cover, the amount of heat generation may be reduced by reducing the operating frequency for the CPU.

The rear cover portion 320 illustrated in FIG. 4B forms a battery cover, for example. Referring to FIG. 4B, the rear cover portion 320 according to various embodiments of the present disclosure is placed on and fixed to the rear surface 101b of the electronic device 101, while covering the rear surface 101b of the electronic device 101. The rear cover portion 320 is removably coupled to the rear surface 101b of the electronic device 101. The battery 430 is removably inserted into the rear surface 101b of the electronic device 101, and the rear cover portion 320 covers the battery 430 and the rear surface 101b of the electronic device 101. The front cover portion 310 is connected to a side surface of the rear cover portion 320. The rear cover portion 320 is coupled to the rear surface 101b of the electronic device 101, and encloses at least a part of the side surface 101c of the electronic device 101 when being closed by flipping of the front cover portion 310. Thus, the electronic device 101 may not leave the cover 300.

According to an embodiment, the connector portion 400 is electrically connected to at least one connection terminal formed on the rear surface 101b of the electronic device 101 as illustrated in FIG. 4B, thus providing type information of the cover 300 to the electronic device 101. For example, a plurality of connection terminals 440 and 450 may be formed on the rear surface 101b of the electronic device 101. In this case, the connector portion 400 of the cover 300 may be engaged with and electrically connected to at least one of the plurality of connection terminals 440 and 450. Thus, the electronic device 101 may identify a type of the cover 300 according to information based on some or all of the connection terminals 440 and 450 that are electrically connected to the connector portion 400 of the cover 300. According to another embodiment, the electronic device 101 may identify type information of the cover 300 based on one of the connection terminals 440 and 450 that is connected to the connector portion 400 of the cover 300.

While the type of the cover 300 is identified using the connection terminals 440 and 450 provided in the electronic device 101 and the connector portion 400 provided on the rear cover portion 320 of the cover 300 as an example, a method for identifying a cover type is not limited to this example. For example, an element for providing cover type information to the electronic device 101 using short-range communication (e.g., Wireless Fidelity (WiFi), Near Field Communication (NFC), Bluetooth (BT), Bluetooth Low Energy (BLE), or a Radio Frequency Identification (RFID)) may be further included in the cover 300.

Although the performance of the electronic device 101 may be adjusted based on the cover type information by adjusting a clock as an example, the performance of the electronic device 101 may also be adjusted based on battery type information. To this end, an element for identifying a type of the battery 430 when the battery 430 is mounted by the user may be provided on the rear surface of the electronic device 101, and the battery 430 may also include an element for providing the battery type information. As an example of the element for providing the battery type information, a connection terminal may be provided in the electronic device 101 and a connector portion electrically connected to the connection terminal may be provided in a battery pack.

For example, since a large-capacity battery is relatively less affected by power consumption of the battery than a small-capacity battery, the performance of the CPU may be increased by increasing the operating speed of the CPU. That is, even if the battery remaining capacity (%) of the large-capacity battery is the same as that of the small-capacity battery, an actually remaining battery capacity (mAh) is sufficient, such that heat generation may be managed by clock adjustment with respect to an increase in the temperature of the CPU, without degrading the performance of the CPU.

As such, according to various embodiments of the present disclosure, the CPU performance may be increased or reduced considering a cover type or a battery type during management of heat generation of the electronic device 101, allowing efficient management of heat generation.

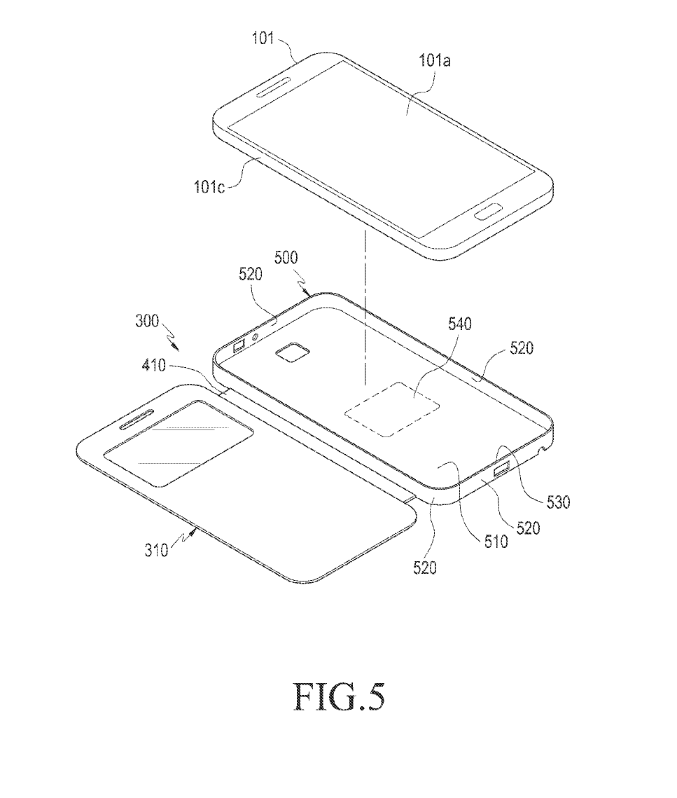

FIG. 5 schematically illustrates a cover of an electronic device according to various embodiments of the present disclosure.

FIG. 5 shows an example where the rear cover portion 320 illustrated in FIG. 4A is formed as a rear case 500. Referring to FIG. 5, the cover 300 according to various embodiments of the present disclosure may include the front cover portion 310, the connecting portion 410, and the rear case 500. In the rear case 500, the electronic device 101 may be inserted and fixed. The electronic device 101 may be inserted into the rear case 500, while the battery cover being coupled to the rear surface 101b of the electronic device 101.

The rear case 500 may include a bottom portion 510, at least one sidewall portions 520 formed along the circumference of the bottom portion 510, and a lock portion 530. The sidewall portions 520 are formed substantially in perpendicular to the bottom portion 510. A lower end of the sidewall portions 520 is connected to the bottom portion 510 and the lock portion 530 is formed on an upper end of the sidewall portions 520. An inner space formed by the bottom portion 510 and the sidewall portions 520 has a size and a shape which correspond to those of the electronic device 101. Once the electronic device 101 is inserted and received in the inner space, the electronic device 101 is prevented from leaving the inner space by the lock portion 530.

As an example of a cover type information providing element for providing the cover type information to the electronic device 101 using short-range communication, a cover type information transmitter 540 may be further formed in the cover 300. The cover type information transmitter 540 may be formed to transmit the cover type information of the cover 300 to the electronic device 101 using short-range communication such as NFC, RFID, BT, WiFi-Direct, or the like. The electronic device 101 identifies the type of the cover 300 based on the cover type information provided using short-range communication from the cover 300.

Although the cover type information providing element is formed on the bottom portion 510 in the rear cover portion 320 of the cover 300 in the description of FIG. 5, the position of the cover type information providing element is not limited to the above example if it makes it possible to provide the cover type information to the electronic device 101. In addition, while the cover 300 has the front cover portion 310 covering the entire display formed on the front surface 101a of the electronic device 101 as an example, the cover 300 may be formed with the rear cover portion 320 which is manufactured to have the same size and shape as those of the exterior of the electronic device 101 and is coupled to the rear surface 101b of the electronic device 101.

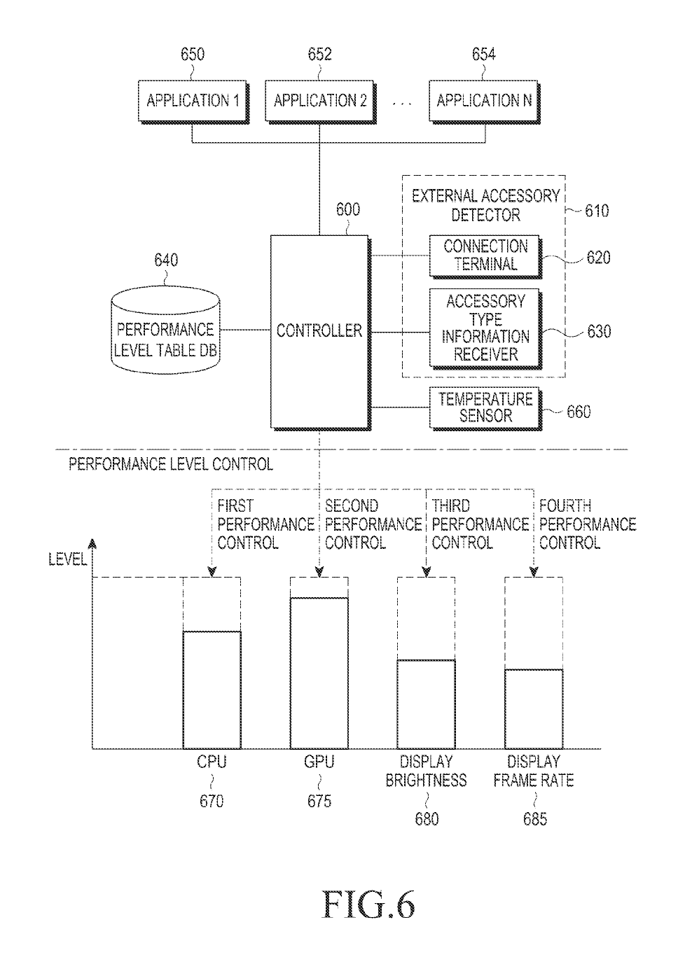

FIG. 6 is a block diagram of an electronic device for managing heat generation according to various embodiments of the present disclosure.

Referring to FIG. 6, a controller 600 according to various embodiments of the present disclosure controls the electronic device 101 (of FIG. 1) to perform various operations based on a set performance factor. Herein, the controller 600 may include a self-calculation device (not shown), such as a CPU, a Graphic Processing Unit (GPU), and so forth, to calculate and process data. In this case, the controller 600 calculates and processes data according to an operating clock of the calculation device included in the controller 600, and as the clock frequency increases, data calculation and processing speeds may increase. As the speed increases, the internal temperature of the electronic device 101 may also increase. The controller 600 may adjust a clock frequency by using clock throttling to adjust the internal temperature. In this way, by reducing the operating frequency of the CPU, the GPU, or the like, the amount of heat generation may be reduced and thus power consumption may also be reduced by operating speed reduction.

According to an embodiment of the present disclosure, the controller 600 detects a type of an external accessory and controls at least one performance factor of a clock frequency, a display brightness, and a display frame rate of at least one element, for example, a calculation device (e.g., a CPU, a GPU, or the like) according to a result of the detection, thereby performing heat generation management. According to another embodiment of the present disclosure, the controller 600 controls a performance factor for at least one element according to a currently executing application, thus performing heat generation management. To this end, the controller 600 may generate and manage a performance level table for controlling at least one of the clock frequency, the display brightness, and the display frame rate for at least one element, for example, a calculation device (e.g., a CPU, a GPU, or the like) at different performance levels for respective applications 650, 652, and 654. Herein, the performance level may be referred to as a performance level.

According to another embodiment of the present disclosure, the controller 600 may control a performance factor for at least one element according to a result of monitoring both an accessory type and a currently executed application, thus performing heat generation management.

An example of a performance factor for controlling a CPU, a GPU, or the like may be a clock frequency for the CPU, the GPU, or the like. For example, if the internal temperature of the electronic device 101 increases, for the CPU or the GPU, the clock frequency may be reduced, the display brightness may be lowered, and the display frame rate may be reduced. For each of the CPU and the GPU, a level of a performance factor for each element, such as a value by which the clock frequency is to be reduced, a value by which the display brightness is to be lowered, and a value by which the display frame rate is to be reduced, may be determined according to a result of monitoring an accessory type and/or an application type. That is, by differently setting a level of a performance factor for each element according to the monitoring result, performance optimized for the current state of the electronic device 101 may be provided.

A performance level table Database (DB) 640 may store a table in which a performance level for controlling a performance factor for at least one element is mapped on a basis of an accessory type and/or an application.

An external accessory detector 610 may include at least one of a connection terminal 620 and an accessory type information receiver 630. The connector terminal 620 may be connected with the connector portion 400 (of FIG. 4A) of the cover 300 (of FIG. 3A, 4A, or FIG. 5), and may receive the cover type information of the cover 300 provided from the connector portion 400 once connected with the connector portion 400. The connection terminal 620 may be formed to receive the battery type information when the battery is coupled to the rear surface 101b of the electronic device 101.

The electronic device 101 may further include the accessory type information receiver 630 to receive the accessory type information from the cover 300 (of FIG. 3A, 4A, or FIG. 5) or the battery 430 (of FIG. 3B). If the accessory type information receiver 630 is configured to have a short-range communication module, the accessory type information may be received by the accessory type information receiver 630 when the cover 300 is coupled to the electronic device 101 or the battery 430 is inserted, mounted, or coupled to the electronic device 101, and the controller 600 may determine a type of the cover or a type of the battery based on the accessory type information received in the accessory type information receiver 630.

The electronic device 101 may further include a monitoring unit. The monitoring unit may monitor state information of the electronic device 101. An example of a monitoring unit is a temperature sensor 660 in FIG. 6. The monitoring unit simultaneously monitors the temperature of heat generation of the electronic device 101, a performance state of the electronic device 101, for example, an RGB value, and state information of the calculation device (e.g., a CPU, a GPU, or the like).

The temperature sensor 660 may include a plurality of temperature sensors attached to elements such as a CPU, a GPU, a battery, or the like in the electronic device 101 to monitor or sense a temperature originating from heat generation of the elements. The temperature sensor 660 may be attached in various positions, for example, adjacent to elements having an influence upon a temperature increase in the electronic device 101.

The controller 600 adjusts a performance level of at least one element associated with heat generation control according to a currently executing application among the plurality of applications 650, 652, and 654 and/or an accessory type detected by the external accessory detector 610. Herein, the at least one element affects heat generation, and may include at least one of a CPU 670, a GPU 675, a display brightness 680, and a display frame rate 685. Assuming that a maximum performance level of each element, such as the CPU 670, the GPU 675, the display brightness 680, and the display frame rate 685 is 100%, levels of performance factors (first performance control, second performance control, third performance control, and fourth performance control) for respective elements are differently adjusted, thus providing optimized performance.

For example, when a user uses the electronic device 101 while holding the electronic device 101 in a hand, a high-temperature heat generation state of the surface of the electronic device 101 may cause inconvenience to user's use of the electronic device 101. Thus, a cover having low heat generation prevention performance may lower the temperature by lowering a performance level of at least one element. On the other hand, for a cover (e.g. the cover 300 of FIG. 3A) having high heat generation prevention performance, when holding the electronic device 101 in a hand for use, the user may feel a smaller amount of heat generation caused by the temperature of a CPU than for the cover having low heat generation prevention performance. Thus, for the cover 300 having high heat generation prevention performance, the CPU may be controlled to operate with high performance than for the cover having low heat generation prevention performance.

For example, the controller 600 may raise the performance level of an element such as a CPU, a GPU, or the like, which is associated with heat generation control, for a game application requiring high performance, and may lower the performance level of an element, such as a display brightness, a display frame rate, or the like, for a music application because the user focuses on listening rather than watching.

In another example, if the game application is executed when the electronic device 101 is coupled to a cover (e.g., the cover 300 of FIG. 3A) having high heat-generation prevention performance, the controller 600 may raise the performance level of an element such as a CPU, a GPU, or the like, which is associated with heat generation control, to the maximum.

As such, the controller 600 raises or lowers the performance of at least one element according to an executed application among the plurality of applications 650, 652, and 654 and/or an accessory type detected by the external accessory detector 610. To this end, the controller 600 variably adjusts a level of a performance factor applied to at least one element to maintain optimal performance while managing a heat generation state.

According to an embodiment, the electronic device 101 may include the monitoring unit and the controller 600.

The monitoring unit may monitor state information of the electronic device 101. According to an embodiment, the monitoring unit may include the temperature sensor 660 for sensing a temperature of heat generated in the electronic device 101 and may monitor the temperature the heat generated in the electronic device 101 and a performance state of the electronic device 101, for example, an RGB value, CPU state information, or the like.

The controller 600 determines a state of the electronic device 101, applies a performance level to the at least one element, corresponding to the state of the electronic device 101, and adjusts the performance level of the at least one element according to the state information. The state of the electronic device 101 may include at least one of contact of an external accessory to the electronic device 101 and execution of at least one application.

The controller 600 may regard the contact of the external accessory as execution of a software-related function. According to an embodiment, to determine the contact of the external accessory, the electronic device 101 may include the external accessory detector 610. The external accessory detector 610 may detect a type of the external accessory coupled to the electronic device 101, and the temperature sensor 660 may sense the temperature of the heat generated by at least one element associated with heat generation.

According to an embodiment, the controller 600 may apply a performance level for the at least one element, corresponding to the state of the electronic device 101, and adjust the performance level for the at least one element according to the state information of the electronic device 101 monitored by the monitoring unit.

According to an embodiment, the type of the external accessory may be one of a type of a cover (e.g., the cover 300 of FIG. 3A) coupled to the electronic device 101 (of FIG. 1) and a type of a battery (e.g., the battery 430 of FIG. 4B) mounted on the rear surface 101b of the electronic device 101.

According to an embodiment, the external accessory detector 610 may receive accessory type information from the external accessory when the external accessory is coupled to the electronic device 101.

According to an embodiment, the at least one element associated with heat generation may include at least one of a CPU, a GPU, a display brightness, and a display frame rate.

According to an embodiment, the memory 130 (of FIG. 1) may store a table in which a performance level for at least one element associated with heat generation is mapped to each element on a basis of a state of the electronic device 101 (of FIG. 1), for example, an external accessory type or an application. According to an embodiment, the table may be stored in an external server (e.g., the server 106 of FIG. 1).

According to an embodiment, the controller 600 may determine whether the table in which a performance level for at least one element associated with heat generation is mapped to each element on a basis of a state of the electronic device 101 is stored in the external server or in the memory 130 (of FIG. 1) of the electronic device 101.

If the table corresponding to the state of the electronic device 101 is stored in the external server, the controller 600 may request the table from the external server. If the table corresponding to the state of the electronic device 101 is stored in the memory 130 (of FIG. 1), the controller 600 may apply the performance level for the at least one element by referring to the table. On the other hand, if the table corresponding to the state of the electronic device 101 is not stored in the memory 130 (of FIG. 1), the controller 600 may apply a performance level predetermined for the at least one element.

According to an embodiment, the controller 600 may adjust the performance level for the at least one element and then update the table stored in the memory 130 (of FIG. 1) by using the adjusted performance level for the at least one element. The updated table may be transmitted to the external server.

According to an embodiment, the controller 600 may manage heat generation by controlling the performance level for the at least one element, and may adjust the performance level by raising or lowering the performance level for the at least one element.

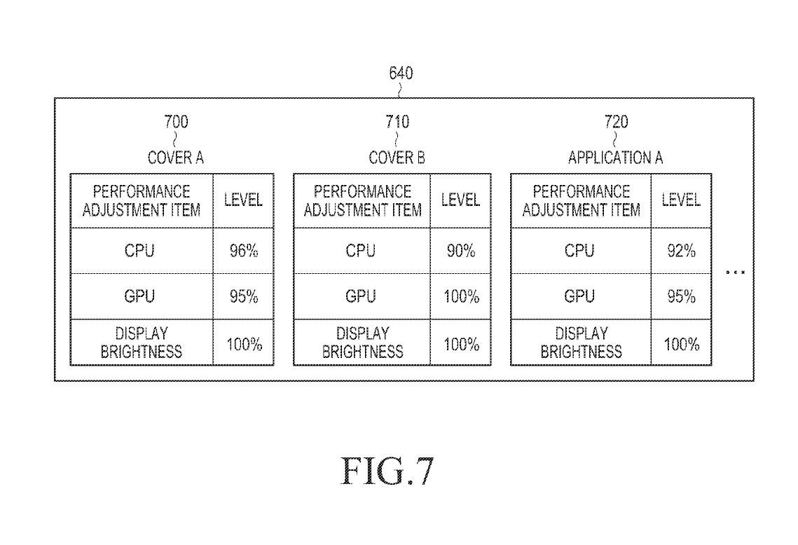

FIG. 7 illustrates a performance level table according to various embodiments of the present disclosure.

Referring to FIG. 7, the performance level table DB 640 stores a table in which a performance level for at least one element is mapped on a basis of an application and/or an accessory type. The performance level table DB 640 may be implemented in the memory 130 or the external server 106 of FIG. 1. If the performance level table DB 640 is implemented in the external server 106, a performance level table may be managed on a basis of a user or type of an electronic device in addition to the above-described performance level table.

For example, the external server 106 may be provided with the latest updated performance level table from the electronic device 101 at predetermined intervals (e.g., once per week) under agreement of a customer, or may provide the performance level table updated by the external server 106 to the electronic device 101. The external server 106 may continuously collect or update a performance level table based on an application, a type of the electronic device 101, or a type or version of software platform.

In another example, if the user has one or more electronic devices, the external server 106 may collect information about the one or more electronic devices based on a user's account and configure a performance level table.

As illustrated in FIG. 7, a performance level table for a cover type A 700 may be stored and managed in which a performance of a CPU is set to 96% of a maximum performance level, a performance of a GPU is set to 95% of the maximum performance level, and a display brightness is set to 100% of the maximum performance level. A performance level table for a cover type B 710 may be stored and managed in which the performance of the CPU is set to 90% of the maximum performance level, the performance of the GPU is set to 100% of the maximum performance level, and the display brightness is set to 100% of the maximum performance level. A performance level table for an application type A 720 may be stored and managed in which the performance of the CPU is set to 92% of the maximum performance level, the performance of the GPU is set to 95% of the maximum performance level, and the display brightness is set to 100% of the maximum performance level. As such, the performance level table may be managed for each accessory type or application.

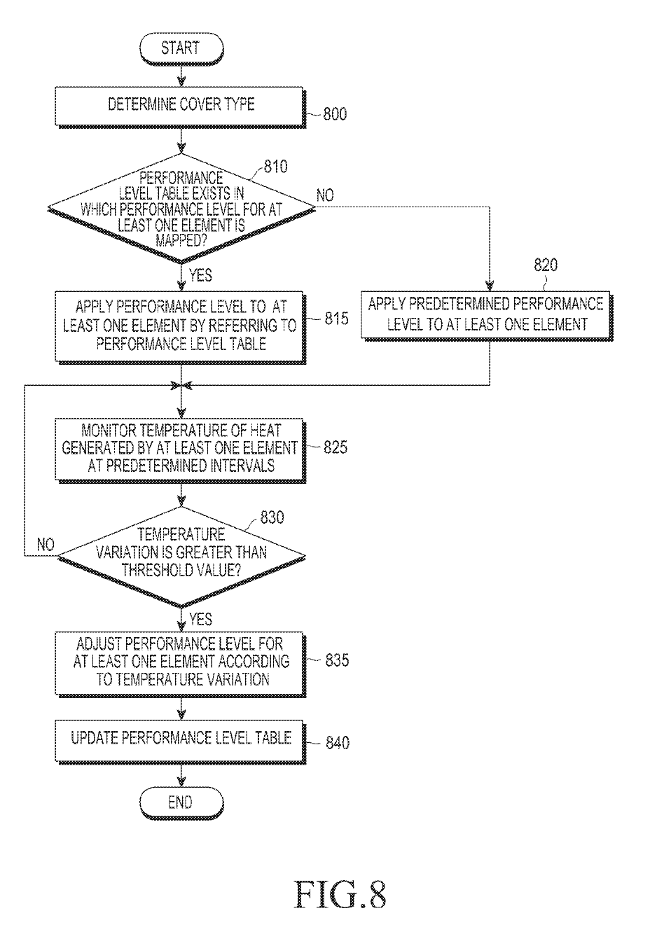

FIG. 8 is a flowchart illustrating performance level adjustment based on an accessory type according to an embodiment of the present disclosure. While a cover as an external accessory is coupled to the electronic device 101 in FIG. 8, the following process may be equally performed when a battery as an external accessory is coupled to the electronic device 101.

Referring to FIG. 8, in operation 800, if the cover 300 is coupled to the electronic device 101, the controller 600 (of FIG. 6) receives cover type information of the cover 300 through a connection terminal and determines a cover type by referring to the received cover type information. Herein, the cover type information may include identification information, for example, an ID, of the cover.

The controller 600 may determine whether a performance level table exists in which a performance level for at least one element is mapped based on a cover type (e.g., the cover type A 700 of FIG. 7) in operation 810. If the performance level table exists, the controller 600 identifies a type of the cover 300 based on the identification information by referring to the table for detail information for each cover type as illustrated in FIG. 7, and determines an item to be adjusted and a value by which the item is to be adjusted in association with heat generation control. Thus, in operation 815, the controller 600 applies a performance level to each of the at least one element by referring to the performance level table. On the other hand, if the performance level for the table 300 is not stored, the controller 600 applies a performance level predetermined for each of the at least one element in operation 820.

In operation 825, the controller 600 monitors a temperature of heat generated by the at least one element at predetermined intervals. If a temperature variation is greater than a threshold value as a result of the monitoring in operation 830, the controller 600 adjusts the performance level for the at least one element according to the temperature variation in operation 835, and updates the performance level table by reflecting the adjustment result in operation 840. Updating the performance level table may be performed if the clock throttling function is disabled when a temperature lowered by a predetermined value than when the clock throttling function is enabled is maintained for a predetermined time. Updating the performance level table may also be performed when the temperature variation is checked more than a predetermined number of times or when the currently executed application is terminated.

On the other hand, if the temperature variation is less than the threshold value, the controller 600 may return to operation 825 to repetitively monitor the temperature of the heat generated by the at last one element at predetermined intervals.

According to various embodiments of the present disclosure, a method for managing heat generation in an electronic device includes determining a state of the electronic device, applying a performance level for at least one element associated with heat generation, corresponding to the state, monitoring state information of the electronic device, and adjusting the performance level for the at least one element according to the state information.

According to various embodiments of the present disclosure, the at least one element associated with heat generation includes at least one of a Central Processing Unit (CPU), a Graphic Processing Unit (GPU), a display brightness, and a display frame rate.

According to various embodiments of the present disclosure, by monitoring at least one of a temperature of heat generated in the electronic device and a performance state of the electronic device, state information of the electronic device is monitored.

According to various embodiments of the present disclosure, the state of the electronic device includes at least one of contact of an external accessory to the electronic device and execution of at least one application.

According to various embodiments of the present disclosure, accessory type information is obtained if the external accessory contacts the electronic device 101, and the performance level for the at least one element is applied, corresponding to the accessory type information. A type of the external accessory is one of a type of a cover (e.g., the cover 300 of FIG. 3A) coupled to the electronic device 101 and a type of a battery mounted on a rear surface of the electronic device.

According to various embodiments of the present disclosure, the method further includes obtaining accessory type information when the external accessory is coupled to the electronic device.

According to various embodiments of the present disclosure, the method further includes determining whether a table exists in an external server (e.g., the server 106 of FIG. 1) or in a memory (e.g., the memory 130 of FIG. 1) of the electronic device 101 in which a performance level for the at least one element associated with heat generation is mapped to the at least one element, corresponding to the state.

According to various embodiments of the present disclosure, applying of the performance level for the at least one element associated with heat generation includes applying the performance level for the at least one element by referring to the table, if the table exists.

According to various embodiments of the present disclosure, applying of the performance level for the at least one element associated with heat generation includes applying a performance level predetermined for the at least one element if the table does not exist.

According to various embodiments of the present disclosure, the method further includes adjusting the performance level for the at least one element and updating and storing the table by using the adjusted performance level for the at least one element.

According to an embodiment, the updated table is transmitted to the external server (e.g., the server 106 of FIG. 1).

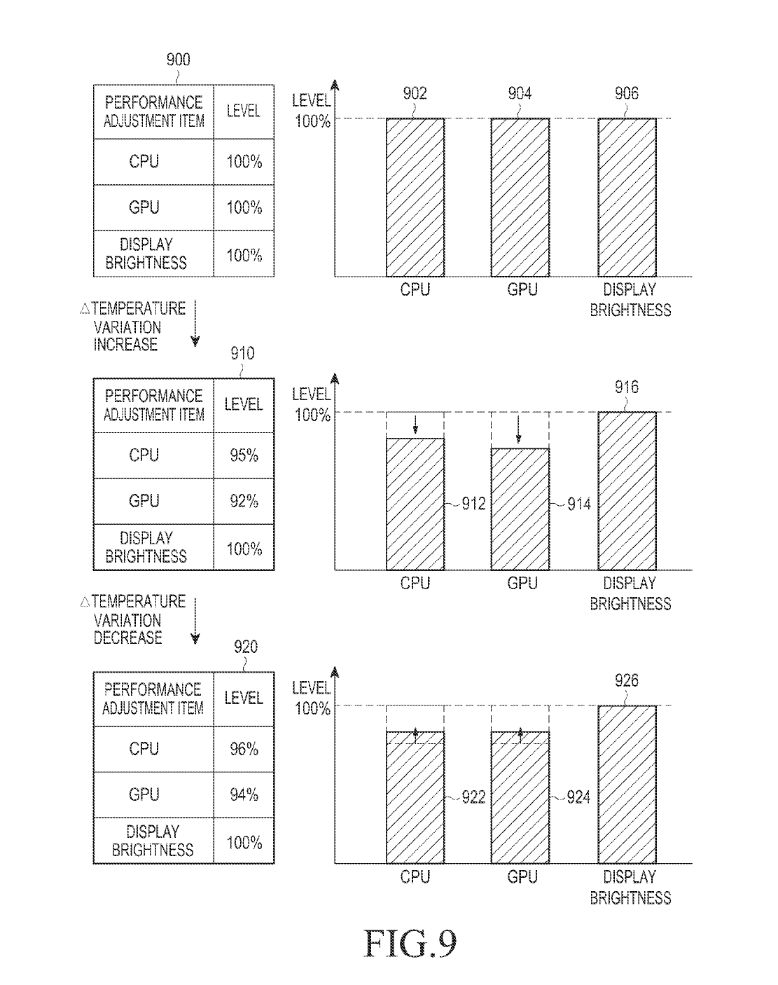

FIG. 9 illustrates performance level adjustment for each configuration element based on a temperature variation according to various embodiments of the present disclosure.

Referring to FIG. 9, the controller 600 (of FIG. 6) according to various embodiments of the present disclosure monitors the temperature of heat generated by at least one element of the electronic device 101 at predetermined intervals. A monitoring start time may be a time at which an accessory (e.g., a cover) is coupled to the electronic device 101 or an application is executed. First, if a performance level table is not stored in advance for a monitoring target, for example, a cover (e.g., the cover 300 of FIG. 3A) or an application (e.g., one or more of the applications 650, 652, 654 of FIG. 6), a performance level for each item 902, 904, or 906 of an initial table 900 may be set to 100%. The controller 600 may calculate a temperature variation based on a temperature measured by the temperature sensor 660 at predetermined intervals. The temperature variation may be checked a predetermined number of times for each monitoring target.

If the temperature increases by a predetermined value or more from the temperature measured by the temperature sensor 660, the controller 600 may lower a performance level of at least one of a plurality of performance adjustment items 902, 904, and 906. The adjusted performance level for each item 912, 914, or 916 of the performance level table 910 may be lowered according to a temperature variation. If the temperature decreases by a predetermined value or more from the temperature measured by the temperature sensor 660, the controller 600 may raise a performance level of at least one of a plurality of performance adjustment items. The adjusted performance level for each item 922, 924, or 926 of the performance level table 910 may be higher than a previous level according to a temperature variation.

For example, if the temperature variation is greater than H1 (+4) on the average, the CPU performance may be lowered by 1 level from an existing set level. If the temperature variation is greater than H2 (+8) on the average, the CPU performance may also be lowered by 2 levels from an existing set level and the GPU performance may also be lowered by 1 level from the existing set level. If the temperature variation is less than L1 (−3) on the average, the CPU performance may be raised by 1 level from the existing set level and the GPU performance may also be raised by 1 level from the existing set level.

The controller 600 according to various embodiments of the present disclosure lowers a performance level for at least one element if the temperature increases by a predetermined value or more from the previously measured temperature. If the temperature decreases by a predetermined value or more from the previously measured temperature, the controller 600 raises a performance level for at least one element. To this end, a load average value, a load maximum value, and a load minimum value of a CPU, a GPU, or the like may be checked and may be classified stepwise into, for example, “serious”, “normal”, and “no problem”. In this way, it is possible to determine a value by which a performance level is to be raised or lowered for each element according to a temperature variation. As such, an element item to be adjusted and an adjustment level for each item may be determined differently according to a temperature variation.

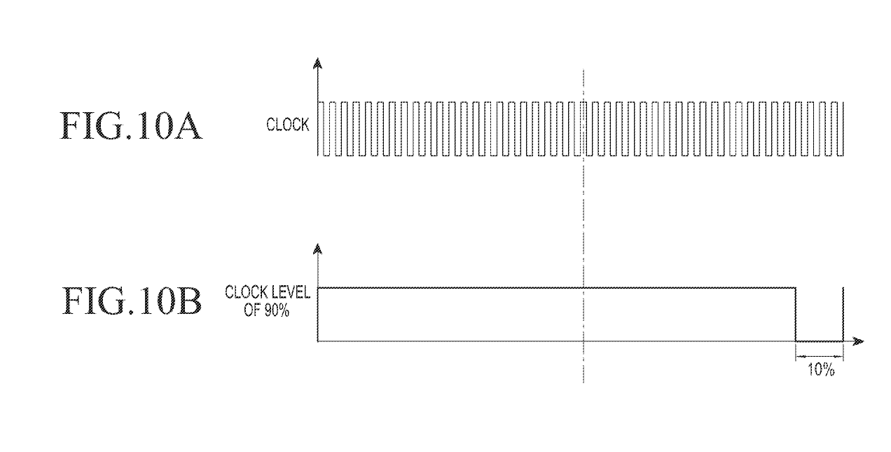

FIG. 10A and FIG. 10B illustrate performance level adjustments according to various embodiments of the present disclosure.

FIG. 10A illustrates a clock frequency of an element, for example, a CPU or a GPU, and FIG. 10B illustrates a clock frequency for a clock level of 90%. If the clock level is reduced to 90%, the clock frequency is enabled and output until the clock level reaches 90%, and the clock frequency is disabled and is not output for the remaining period of 10%. When the clock frequency is disabled, an internal operation of the CPU or the GPU is temporarily stopped, such that power consumption is reduced and the temperature decreases.

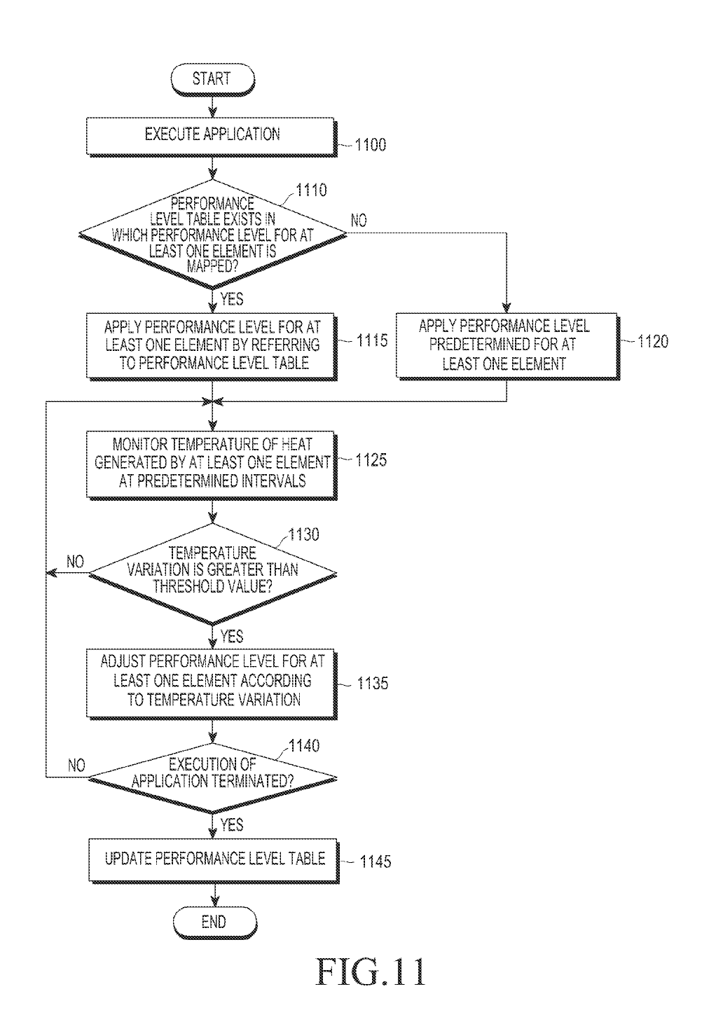

FIG. 11 is a flowchart illustrating performance level adjustment based on an application according to another embodiment of the present disclosure.

Referring to FIG. 11, once execution of an application starts in operation 1100, the controller 600 identifies the application. In operation 1110, the controller 600 determines whether a performance level table exists in which a performance level is mapped to at least one element, corresponding to the application.

If the performance level table exists, the controller 600 may determine an item to be adjusted and a value by which the item is to be adjusted in association with heat generation control for the currently executed application, by referring to the table in which the performance level is mapped for each application as illustrated in FIG. 7.

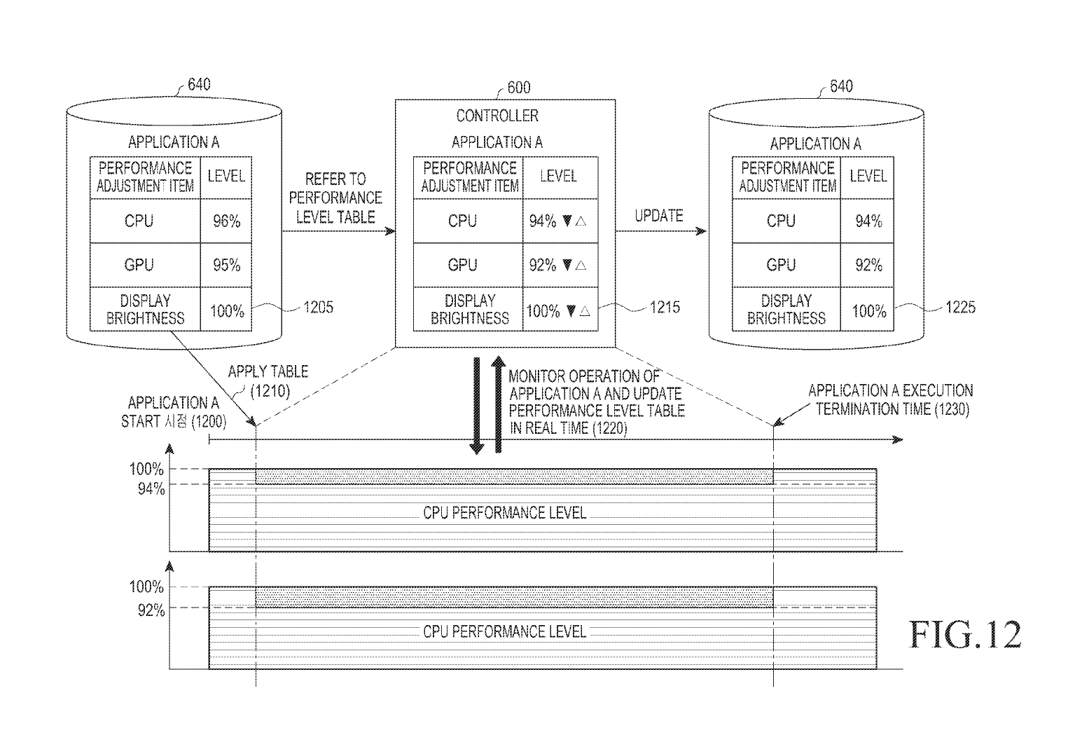

Referring to FIG. 12, after an application execution start point 1200, if a performance level table 1205 for the application exists in performance level table DB 640, values of the performance level table 1205 may be applied as indicated by 1210. Thus, in operation 1115, the controller 600 may apply the performance level for the at least one element by referring to the performance level table 1205. That is, if a performance level table exists for a currently executed application, the controller 600 may control the application to be executed in a state where performance is limited according to values of the performance level table. For example, according to the values of the performance level table, the electronic device 101 may operate with the CPU performance level or the GPU performance level being lowered.

On the other hand, if the performance level table for the currently executed application does not exist, the controller 600 applies a performance level predetermined for the at least one element in operation 1120. For example, the controller 600 may apply 100% of a maximum performance level for the at least one element.

The controller 600 then monitors a temperature of heat generated by the at least one element at predetermined intervals in operation 1125. If a temperature variation is greater than a threshold value in operation 1130, the controller 600 adjusts a performance level for the at least one element according to the temperature variation in operation 1135. As illustrated in FIG. 12, the controller 600 may update a performance level table 1215 on a real time basis, while monitoring an operation of the application being executed after application of the performance level table 1205.

If execution of the application is terminated in operation 1140, the controller 600 reflects an adjustment result to update the performance level table 1205 into a performance level table 1225 and stores the performance level table 1225 in operation 1145. As illustrated in FIG. 12, the controller 600 may release the applied values of the performance level table, simultaneously with storing the real-time updated performance level table at an application execution termination time 1230. That is, if execution of the application resumes after termination of execution of the application, the finally updated performance level table 1225, instead of the previous performance level table 1205, is applied, and since the values of the table (1225) are only effective for the application, the applied values may be released after termination of execution of the application. If the performance level table has not been updated to a predetermined extent, a temperature at the application execution start time is measured. If the measured temperature is higher than a predetermined temperature, that is, in case of a heat generation situation higher than a threshold temperature, a monitoring result in the heat generation situation is not suitable for use as a value of a performance level table, such that a monitoring operation for updating values of the performance level table may not be performed.

On the other hand, unless a temperature variation is greater than the threshold value or unless execution of the currently executed application is terminated, the controller 600 may return to operation 1125 to repeat monitoring of the temperature of the heat generated by the at least one element at predetermined intervals. In this case, measurement of the temperature variation is performed N times, and the performance level table is updated using average values of N-time measurement.

For example, for a game application, high performance is required for a CPU or a GPU, and thus a large amount heat may be generated due to a load of the CPU or the GPU. In this case, a performance level for the CPU or the GPU may be lowered from the maximum performance level. Thus, when execution of the game application resumes, the game application may be executed with the performance level of the CPU or the GPU being lowered.

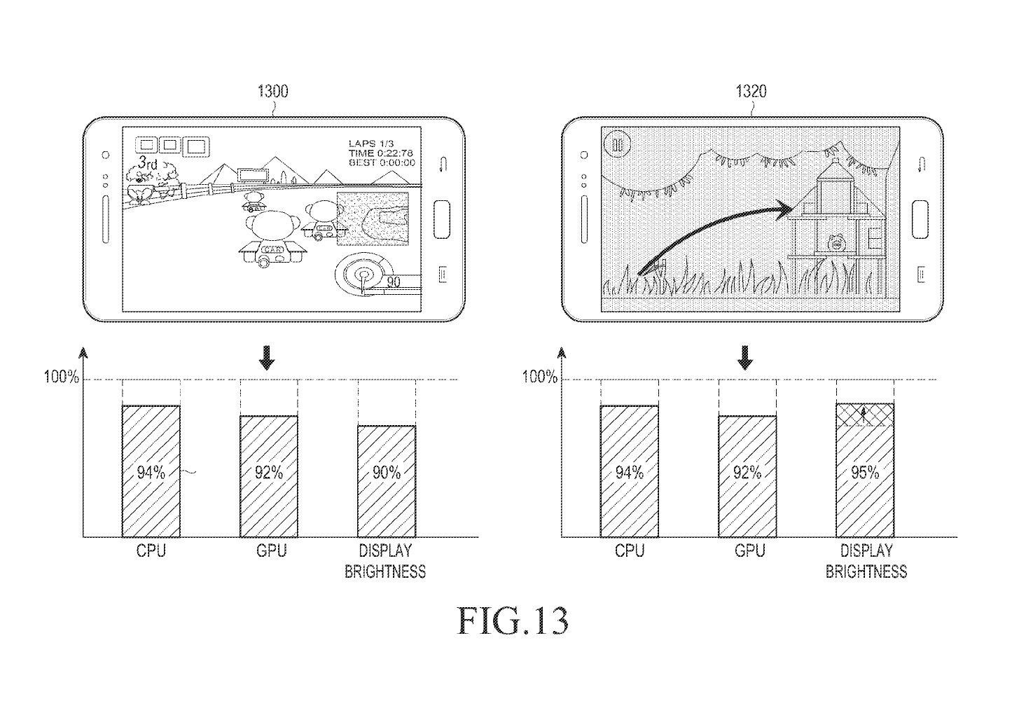

With reference to FIG. 13, a description will be made of adjustment of a performance level for a display brightness in addition to the performance level for the CPU or the GPU.

FIG. 13 illustrates a process of adjusting a performance level based on a type of an application according to various embodiments of the present disclosure.

Referring to FIG. 13, for an execution screen 1300 of an application A, if an RGB average value is in a first threshold value range with respect to white of 100%, a display brightness may be lowered to a predetermined level. For an execution screen 1320 of an application B, if an RGB average value is in a second threshold value range, a display brightness may be raised to a predetermined level from the previous level. To this end, the controller 600 or an LCD driver part may check an RGB average value N times every execution of each application, and register in a performance level table, an application which uses an RGB value having a brightness higher than a first brightness continuously for a predetermined time or longer.

For example, for an application registered as ‘bright’ corresponding to the first threshold value range, a display brightness may be corrected to be darker by a predetermined level and may be updated in the performance level table. To this end, if the temperature of the generated heat exceeds a threshold temperature and additional correction is required, an RGB value may be checked in real time to detect a white screen, and when the white screen is detected, the display brightness may be corrected in real time. For an application registered as ‘normal’ corresponding to the second threshold value range, a display brightness may be corrected to be brighter by a predetermined level and may be updated in the performance level table. In this case, the display brightness may be corrected such that only a part of the display becomes brighter. On the other hand, for an application registered as ‘very dark’ corresponding to a third threshold value range, an existing level may be maintained.

While the above description has been made of a case where a performance level table is configured based on a display brightness, for example, an RGB value, the performance level table may also be configured based on a display frame rate, that is, a frame per second (FPS) of an application.

To this end, the controller 600 may check the FPS of the currently executed application N times to obtain an average FPS, a maximum frame drop, a minimum frame drop, and so forth, and use them as elements for controlling performance. For example, if an average FPS is about 50FPS, but a measured FPS is 30FPS, a performance level may be lowered, and when an FPS is lowered by about Y (e.g., 40%) with respect to an average, the performance level of a CPU or a GPU may be increased to compensate for a frame drop. On the other hand, if an FPS is lowered by about Z (e.g., 15%) with respect to an average, the performance level of a GPU or a GPU may be maintained the same as the existing performance level.

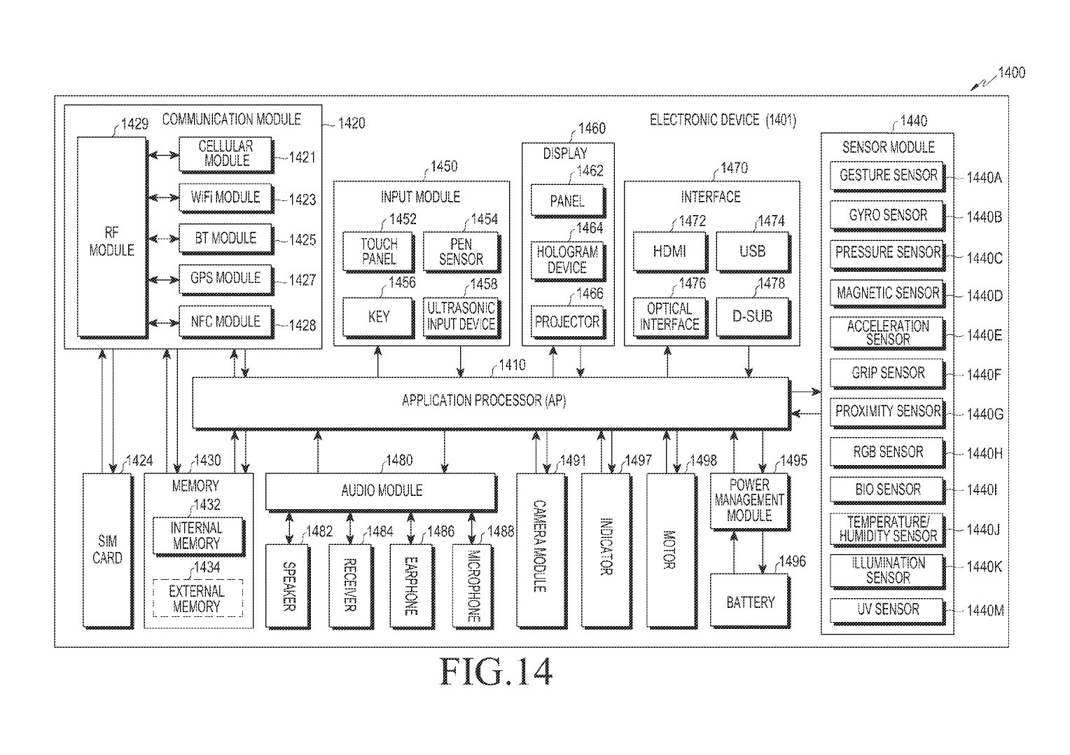

FIG. 14 is a block diagram 1400 of an electronic device according to various embodiments of the present disclosure.

Referring to FIG. 14, an electronic device 1401 may form the entire electronic device 101 illustrated in FIG. 1 or a part of the electronic device 101 illustrated in FIG. 1. The electronic device 1401 may include one or more Application Processors (APs) 1410, a communication module 1420, a Subscriber Identification Module (SIM) card 1424, a memory 1430, a sensor module 1440, an input module 1450, a display 1460, an interface 1470, an audio module 1480, a camera module 1491, a power management module 1495, a battery 1496, an indicator 1497, and a motor 1498.

The AP 1410 controls multiple hardware or software components connected to the AP 1410 by driving an Operating System (OS) or an application program, and performs processing and operations with respect to various data including multimedia data. The AP 1410 may be implemented with, for example, a System on Chip (SoC). According to an embodiment, the AP 1410 may further include a Graphic Processing Unit (GPU) and/or an image signal processor. The AP 1410 may include at least some of the elements illustrated in FIG. 14 (e.g., the cellular module 1421). The AP 1410 loads a command or data received from at least one of other elements (e.g., a non-volatile memory) into a volatile memory and processes the command or data and stores various data in the non-volatile memory.

The communication module 1420 may have a configuration that is the same as or similar to the communication interface 170 illustrated in FIG. 1. The communication module 1420 may include, for example, the cellular module 1421, a WiFi module 1423, a Bluetooth (BT) module 1425, a Global Positioning System (GPS) module 1427, a Near Field Communication (NFC) module 1428, and a Radio Frequency (RF) module 1429.

The cellular module 1421 may provide, for example, a voice call, a video call, a text service, or an Internet service over a communication network. According to an embodiment, the cellular module 1421 may identify and authenticate the electronic device 1401 in a communication network by using a subscriber identification module (e.g., the SIM card 1424). According to an embodiment, the cellular module 1421 performs at least one of functions that may be provided by the AP 1410. According to an embodiment, the cellular module 1421 may include a Communication Processor (CP).

Each of the WiFi module 1423, the BT module 1425, the GPS module 1427, and the NFC module 1428 may include a processor for processing data transmitted and received by a corresponding module. According to some embodiment, at least some (e.g., two or more) of the cellular module 1421, the WiFi module 1423, the BT module 1425, the GPS module 1427, and the NFC module 1428 may be included in one Integrated Chip (IC) or IC package.

The RF module 1429 may transmit and receive a communication signal (e.g., an RF signal). The RF module 1429 may include a transceiver, a Power Amp Module (PAM), a frequency filter, a Low Noise Amplifier (LNA), or an antenna. According to another embodiment, at least one of the cellular module 1421, the WiFi module 1423, the BT module 1425, the GPS module 1427, and the NFC module 1428 may transmit and receive an RF signal through the separate RF module 1429.

The SIM card 1424 may include a card including an SIM and/or an embedded SIM, and may include unique identification information (e.g., an Integrated Circuit Card Identifier (ICCID) or subscriber information (e.g., an International Mobile Subscriber Identity (IMSI)).

The memory 1430 may include an internal memory 1432 or an external memory 1434. The internal memory 1432 may include at least one of a volatile memory (e.g., Dynamic Random Access Memory (DRAM), Static RAM (SRAM), Synchronous Dynamic RAM (SDRAM), and a non-volatile memory (e.g., One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, or NOR flash memory), and a Solid State Drive (SSD).

The external memory 1434 may further include flash drive, for example, Compact Flash (CF), Secure Digital (SD), micro-SD, mini-SD, extreme Digital (xD), or a memory stick. The external memory 1434 may be functionally and/or physically connected with the electronic device 1401 through various interfaces.

The sensor module 1440 measures physical quantity or senses an operation state of the electronic device 1401 to convert the measured or sensed information into an electric signal. The sensor module 1440 may include at least one of a gesture sensor 1440A, a gyro sensor 1440B, a pressure sensor 1440C, a magnetic sensor 1440D, an acceleration sensor 1440E, a grip sensor 1440F, a proximity sensor 1440G, a color sensor 1440H (e.g., RGB sensor), a bio sensor 1440I, a temperature/humidity sensor 1440J, an illumination sensor 1440K, and a Ultraviolet (UV) sensor 1440M. Additionally or alternatively, the sensor module 1440 may include an E-nose sensor (not shown), an Electromyography (EMG) sensor (not shown), an Electroencephalogram (EEG) sensor (not shown), an Electrocardiogram (ECG) sensor (not shown), or a fingerprint sensor. The sensor module 1440 may further include a control circuit for controlling at least one sensor included therein. In some embodiment, the electronic device 1401 may further include a processor configured to control the sensor module 1440 as part of or separately from the AP 1410, to control the sensor module 1440 during a sleep state of the AP 1410.

The input module 1450 may include a touch panel 1452, a (digital) pen sensor 1454, a key 1456, or an ultrasonic input device 1458. The touch panel 952 may use at least one of a capacitive type, a resistive type, an IR type, or an ultrasonic type. The touch panel 1452 may further include a control circuit. The touch panel 1452 may further include a tactile layer to provide tactile reaction to the user.

The (digital) pen sensor 1454 may include a recognition sheet which is a part of the touch panel 1452 or a separate recognition sheet. The key 1456 may also include a physical button, an optical key, or a keypad. The ultrasonic input device 1458 is a device through which the electronic device 1401 senses ultrasonic waves input through a microphone (e.g., the microphone 1488) using an input means for generating an ultrasonic signal to check data.

The display 1460 may include a panel 1462, a hologram 1464, or a projector 1466. The panel 1462 may have a configuration that is the same as or similar to that of the display 1460 of FIG. 1. The panel 1462 may be implemented to be flexible, transparent, or wearable. The panel 1462 may be configured with the touch panel 1452 in one module. The hologram 1464 shows a stereoscopic image in the air by using interference of light. The projector 1466 displays an image onto an external screen through projection of light. The screen may be positioned inside or outside the electronic device 1401. According to an embodiment, the display 1460 may further include a control circuit for controlling the panel 1462, the hologram 1464, or the projector 1466.

The interface 1470 may include a High-Definition Multimedia Interface (HDMI) 1472, a Universal Serial Bus (USB) 1474, an optical communication 1476, or a D-subminiature 1478. The interface 1470 may be included in the communication interface 160 illustrated in FIG. 1. Additionally or alternatively, the interface 1470 may include a Mobile High-Definition Link (MHL) interface, an SD/Multi-Media Card (MMC) interface, or an Infrared Data Association (IrDA) interface.

The audio module 1480 bi-directionally converts sound and an electric signal. At least one element of the audio module 1480 may be included in the input/output interface 150 illustrated in FIG. 1. The audio module 1480 processes sound information input or output through the speaker 1482, the receiver 1484, the earphone 1486, or the microphone 1488.

The camera module 1491 is a device capable of capturing a still image or a moving image, and according to an embodiment, may include one or more image sensors (e.g., a front sensor or a rear sensor), a lens, an Image Signal Processor (ISP), or a flash (e.g., an LED or a xenon lamp).

The power management module 1495 manages power of the electronic device 1401. According to an embodiment, the power management module 1495 may include a Power Management Integrated Circuit (PMIC), a charger IC, or a battery fuel gauge. The PMIC may have a wired and/or wireless charging scheme. The wireless charging scheme includes a magnetic-resonance type, a magnetic induction type, and an electromagnetic type, and for wireless charging, an additional circuit, for example, a coil loop, a resonance circuit, or a rectifier may be further included. The battery gauge measures the remaining capacity of the battery 1496 or the voltage, current, or temperature of the battery 1496 during charging. The battery 1496 may include a rechargeable battery and/or a solar battery.

The indicator 1497 displays a particular state, for example, a booting state, a message state, or a charging state, of the electronic device 1401 or a part thereof (e.g., the AP 1410). The motor 1498 converts an electric signal into mechanical vibration or generates vibration or a haptic effect. Although not shown, the electronic device 1401 may include a processing device (e.g., a GPU) for supporting a mobile TV. The processing device for supporting the mobile TV processes media data according to, a standard such as Digital Multimedia Broadcasting (DMB), Digital Video Broadcasting (DVB), or a Media Flow.

Each of the foregoing elements of the electronic device 1401 according to the present disclosure may include one or more components and a name of the part may vary with a type of the electronic device 1401. The electronic device according to the present disclosure may include at least one of the foregoing elements, and some of the elements may be omitted therefrom or other elements may be further included therein. As some of the elements of the electronic device 1401 according to the present disclosure are coupled into one entity, thereby performing the same function as those of the elements that have not been coupled.

According to various embodiments of the present disclosure, a heat generation problem of an electronic device may be handled in advance, minimizing a temperature increase. Moreover, according to various embodiments of the present disclosure, a performance level for each application may be managed in the form of a table and may be continuously updated, thus improving reliability.

In addition, according to various embodiments of the present disclosure, when an external accessory such as a cover is mounted on an electronic device, the performance may be increased or reduced according to a type of the external accessory, thereby providing optimized performance and effectively controlling heat generation.

Furthermore, according to various embodiments of the present disclosure, by referring to a table in which the performance level is adjusted based on a result of monitoring a temperature for a currently executed application, optimal performance may be maintained.

The effects of the present disclosure are not limited to the above-described effects, and it would be obvious to those of ordinary skill in the art that various effects are included in the present disclosure.

Embodiments of the present disclosure disclosed in the specification and the drawings merely present specific examples to easily describe the technical details of the present disclosure and help to understand the present disclosure and are not intended to limit the scope of the present disclosure. Accordingly, it should be construed that any change or modified embodiment derived based on the technical spirit of various embodiments of the present disclosure as well as embodiments disclosed herein is included in the scope of various embodiments of the present disclosure.

1. A method for managing heat generation in an electronic device, the method comprising:
determining a state of the electronic device;
applying a performance level for at least one element associated with heat generation, corresponding to the state;
monitoring state information of the electronic device; and
adjusting the performance level for the at least one element according to the state information.

2. The method of claim 1, wherein the at least one element associated with heat generation comprises at least one of a Central Processing Unit (CPU), a Graphic Processing Unit (GPU), a display brightness, and a display frame rate.

3. The method of claim 1, wherein the state of the electronic device comprises at least one of contact of an external accessory to the electronic device and execution of at least one application.

4. The method of claim 3, further comprising determining whether a table exists in an external server or the electronic device in which a performance level for the at least one element associated with heat generation is mapped to the at least one element, corresponding to the state.

5. The method of claim 4, further comprising adjusting the performance level for the at least one element and updating the table by using the adjusted performance level for the at least one element.

6. The method of claim 5, further comprising transmitting the updated table to the external server.

7. The method of claim 4, wherein the applying of the performance level for the at least one element associated with heat generation comprises:
applying the performance level for the at least one element by referring to the table, if the table exists; and
applying a performance level predetermined for the at least one element if the table does not exist.

8. The method of claim 3, wherein the applying of the performance level for the at least one element associated with heat generation comprises:
obtaining accessory type information if the external accessory contacts the electronic device; and
applying the performance level for the at least one element, corresponding to the accessory type information.

9. The method of claim 8, wherein a type of the external accessory is one of a type of a cover coupled to the electronic device and a type of a battery mounted on a rear surface of the electronic device.

10. The method of claim 1, wherein the monitoring of the state information of the electronic device comprises monitoring at least one of a temperature of heat generated in the electronic device and a performance state of the electronic device.

11. An electronic device for managing heat generation, the electronic device comprising;
a monitoring unit configured to monitor state information of the electronic device; and
a controller configured to determine a state the electronic device, to apply a performance level for at least one element associated with heat generation, corresponding to the state, and to adjust the performance level for the at least one element according to the state information.

12. The electronic device of claim 11, wherein the at least one element associated with heat generation comprises at least one of a Central Processing Unit (CPU), a Graphic Processing Unit (GPU), a display brightness, and a display frame rate.

13. The electronic device of claim 11, wherein the state of the electronic device comprises at least one of contact of an external accessory to the electronic device and execution of at least one application.

14. The electronic device of claim 11, wherein the controller determines whether a table exists in an external server or in a memory of the electronic device in which a performance level for the at least one element associated with heat generation is mapped to the at least one element, corresponding to the state.

15. The electronic device of claim 14, wherein the controller adjusts the performance level for the at least one element and updates the table by using the adjusted performance level for the at least one element.

16. The electronic device of claim 15, wherein the controller transmits the updated table to the external server through a communication interface.

17. The electronic device of claim 14, wherein the controller applies the performance level for the at least one element by referring to the table, if the table exists in the memory of the electronic device, and applies a performance level predetermined for the at least one element if the table does not exist.

18. The electronic device of claim 13, wherein the controller obtains accessory type information if the external accessory contacts the electronic device and applies the performance level for the at least one element, corresponding to the accessory type information.

19. The electronic device of claim 18, wherein a type of the external accessory is one of a type of a cover coupled to the electronic device and a type of a battery mounted on a rear surface of the electronic device.

20. The electronic device of claim 11, wherein the monitoring unit comprises a temperature sensor for sensing a temperature of heat generated in the electronic device, and monitors at least one of the temperature of the generated heat using the temperature sensor and a performance state.
